(19) United States
(12) Patent Application Publication
(10) Pub. No.: US 2024/0239116 A1
(43) Pub. Date: Jul. 18, 2024

(54) MEDIUM SUPPORT DEVICE AND RECORDING DEVICE

(71) Applicant: SEIKO EPSON CORPORATION, Tokyo (JP)

(72) Inventors: Satoru MIYAMOTO, Matsumoto-Shi (JP); Yusuke KATO, Shiojiri-shi (JP); Yutaka NAGASHIMA, Matsumoto-Shi (JP); Nobuaki SAKAI, Shiojiri-shi (JP)

(21) Appl. No.: 18/504,218

(22) Filed: Nov. 8, 2023

(30) Foreign Application Priority Data
Nov. 8, 2022 (JP) 2022-178666

(51) Int. Cl. B41J 11/06; B41J 3/407; B41J 11/14; D06P 5/30

(52) U.S. Cl. CPC B41J 11/06; B41J 3/4078; B41J 11/14; D06P 5/30

(57) ABSTRACT

A medium support device 7 includes a support base 5 that supports a T-shirt F; a movement mechanism 6 that supports the support base 5 so that the support base 5 is movable in a direction along a Z-axis; a base section 8 configured to support the movement mechanism 6; and a spacer 10 arranged between the movement mechanism 6 and the base section 8 in the direction along the Z-axis, wherein the spacer 10 can be inserted and pulled out in a direction along a Y-axis.

The present application is based on, and claims priority from JP Application Serial Number 2022-178666, filed Nov. 8, 2022, the disclosure of which is hereby incorporated by reference herein in its entirety.

### BACKGROUND

### 1. Technical Field

The present disclosure relates to a medium support device and a recording device.

### 2. Related Art

In the related art, a recording device that prints a pattern or the like on a fabric medium such as a T-shirt has been known. Some of the recording devices include a medium support device that supports a medium. For example, JP-A-2014-97585 discloses a medium support device that includes a spacer that is configured to attach and detach according to thickness of a medium.

However, there is a problem that it is difficult to improve workability of attaching and detaching the spacer in the medium support device described in JP-A-2014-97585. Specifically, when the spacer is attached, a substantially ring-shaped spacer is fitted into a fitting section of an arm. Therefore, when the spacer is attached or detached, it is necessary to detach a stage and a rotary lever, which are configurations located above the spacer. In other words, there is a desire for a medium support device that improves workability of attaching and detaching the spacer.

### SUMMARY

A medium support device includes a support base that supports a medium; a movement mechanism that supports the support base so that the support base is movable in a vertical direction; a base section configured to support the movement mechanism; and a spacer arranged between the movement mechanism and the base section in the vertical direction, wherein the spacer is configured to be inserted and pulled out in a direction intersecting the vertical direction.

A recording device includes a recording head that applies ink to a medium and a medium support device, wherein the medium support device includes a support base that supports the medium, a movement mechanism that supports the support base so that the support base is movable in a vertical direction, a base section configured to support the movement mechanism, and a spacer arranged between the movement mechanism and the base section in the vertical direction and the spacer is configured to be inserted and pulled out in a direction intersecting the vertical direction.

### BRIEF DESCRIPTION OF THE DRAWINGS

FIG. 1 is a perspective view showing configuration of a recording device according to an embodiment.

FIG. 2 is a front view showing configuration of the recording device.

FIG. 3 is a perspective view showing configuration of a medium support device.

FIG. 4 is a side view showing outer appearance of the medium support device.

FIG. 5 is a side view showing outer appearance of the medium support device to which a cover, a protective wall, and the like are attached.

FIG. 6 is a perspective view showing arrangement of a movement mechanism and the like.

FIG. 7 is a perspective view showing an aspect of the medium support device from which the movement mechanism and a spacer are detached.

FIG. 8 is a perspective view showing outer appearance of the spacer.

FIG. 9 is a perspective view showing outer appearance of the spacer.

FIG. 10 is a perspective view showing a state in which the spacer is attached to a base section.

FIG. 11 is an enlarged cross-sectional view of a main section of the medium support device.

### DESCRIPTION OF EMBODIMENTS

In the embodiments described below, a recording device that performs printing of an image or the like on a fabric medium such as a T-shirt, one by one, and a medium support device included in the recording device will be exemplified and described with reference to drawings.

In each of the following drawings, as necessary, XYZ axes are provided as coordinate axes orthogonal to each other, a direction indicated by each arrow is a “+” direction, and a direction opposite to the “+” direction is a “−” direction. An X-axis is along a left-right direction of a recording device 1, and a +X direction of the recording device 1 is defined as a right direction and a −X direction is defined as a left direction.

A Y-axis is along a front-rear direction of the recording device 1, and a +Y direction of the recording device 1 is defined as a front direction, and a −Y direction is defined as a rear direction. A vertical direction is a direction along a Z-axis. A +Z direction in the recording device 1 is defined as an upward direction, and the −Z direction is defined as a downward direction. In the present specification, a state where the recording device 1 is installed on a surface along a horizontal plane will be described.

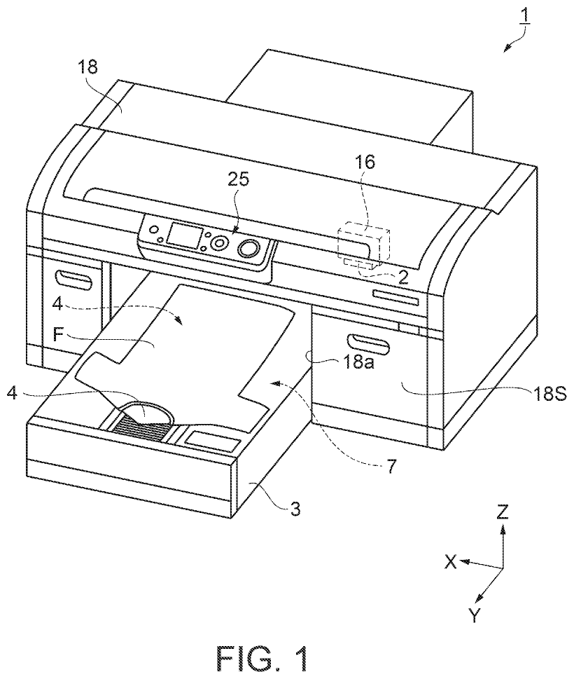

As shown in FIG. 1, the recording device 1 according to the present embodiment includes a recording head 2, a transport section 3, a tray 4, a medium support device 7, and a housing 18. Although not shown, the recording device 1 includes a control section that integrally controls operations of various configurations inside the housing 18. The recording device 1 is an inkjet printer. The medium support device 7 is an example of the medium support device of the present disclosure. Use of the medium support device of the present disclosure is not limited to being mounted on an inkjet printer or the like.

FIG. 1 shows a state in which a T-shirt F as a medium is set on the tray 4. The T-shirt F can be set in any direction, but in the above-described state, a chest side of the T-shirt F faces upward. The tray 4 is a substantially flat plate-shaped member, and has a main surface along an XY plane.

In the present specification, setting of the T-shirt F includes a case where the T-shirt F is installed on the medium support device 7 in a state where at least a part of the tray 4 is placed inside the T-shirt F, and a case where the T-shirt F is placed on an upper surface of the tray 4. In the following description, unless otherwise specified, a description will be given of attaching, wherein the tray 4 is installed on the medium support device 7 with a part of the tray 4 located inside the T-shirt F.

The housing 18 is a housing having a substantially rectangular parallelepiped shape, and covers and accommodates the recording head 2, a carriage 16, and other various configurations. An operation panel 25 is arranged in front direction and upward direction of the housing 18. The housing 18 includes a side wall 18S facing the +Y direction and a plurality of other side walls (not shown).

The operation panel 25 has a display function of displaying various kinds of information regarding operations of the recording device 1, and an input function of receiving various kinds of instructions corresponding to operating conditions and the like. The operation panel 25 includes, for example, a touch panel type liquid crystal display device. The operation panel 25 is electrically connected to the control section. The operation panel 25 may include various buttons in addition to the liquid crystal display device. Various instructions related to an operation of the recording device 1 may be input to the recording device 1 via an information terminal such as a personal computer.

The recording head 2 is arranged in the downward direction from the carriage 16. The recording head 2 performs printing by applying ink to an upward facing surface of the T-shirt F. Although not shown, the recording head 2 includes a nozzle surface at a position facing downward. The nozzle surface faces a platen (to be described later) in vertical direction when printing is performed by the recording device 1. A plurality of nozzle arrays are arranged on the nozzle surface.

Each of the plurality of nozzle arrays is formed of a plurality of nozzles, and each of the nozzle arrays individually ejects ink of colors such as cyan, magenta, yellow, black, or white. These inks are supplied to the recording head 2 through a pipe from an ink container (not shown) accommodated in the housing 18. Ink ejected from the recording head 2 may be liquid such as clear ink or treatment liquid, in addition to the ink of each color described above.

A piezoelectric element is applied to the recording head 2 as an actuator which is a driving unit for ejecting ink. As a driving unit other than a piezoelectric element may be used, for example, an electromechanical conversion element which displaces a vibration plate as an actuator by electrostatic attraction or an electrothermal conversion element which ejects ink by bubbles generated by heating.

Although not shown, the carriage 16 is connected to a timing belt, and the timing belt is driven by a carriage motor. The timing belt moves the carriage 16 in the left-right direction, which is a main scanning direction, by driving the carriage motor.

In the housing 18, an opening section 18a is provided in the downward direction of the side wall 18S. The transport section 3 is arranged so as to protrude forward from the opening section 18a. A tray 4 is installed above the transport section 3 via the medium support device 7.

The platen described above refers to a region of an upper main surface of the tray 4 that faces the recording head 2 when printing is performed by the recording device 1. That is, the T-shirt F set on the tray 4 is printed on the platen.

The transport section 3 moves the medium support device 7 and the tray 4 in a direction along the Y-axis by driving a transport motor (not shown). In other words, the tray 4 can be moved by the transport section 3 to a region including a position facing the recording head 2.

Printing is started in a state where the tray 4 and the medium support device 7 are retracted from the positions shown in FIG. 1. Then, the tray 4 relatively moves in the +Y direction or the −Y direction with respect to the recording head 2, and the recording head 2 reciprocates in the left-right direction with respect to the platen. Thus, a desired image or the like is printed on the upward facing surface of the T-shirt F set on the tray 4. A surface of the T-shirt F to be printed is not limited to a chest side of a wearer of the T-shirt F, and may be, for example, a back side.

During printing, the tray 4 and the medium support device 7 can be retracted to a position where the tray 4 and the medium support device 7 protrude rearward from a rearward facing side surface of the housing 18. Therefore, printing can be performed on the T-shirt F set on the tray 4, even in a region near an end section of the tray 4 in the +Y direction. As shown in FIG. 1, the tray 4 and the medium support device 7 are covered with an auxiliary housing at a position where the tray 4 and the medium support device 7 protrude rearward from a side surface of the housing 18 facing rearward. Therefore, the tray 4 and the medium support device 7 are not exposed even when, during printing, the tray 4 and the medium support device 7 are withdrawn to a position where the tray 4 and the medium support device 7 protrude rearward from the rearward facing side surface of the housing 18.

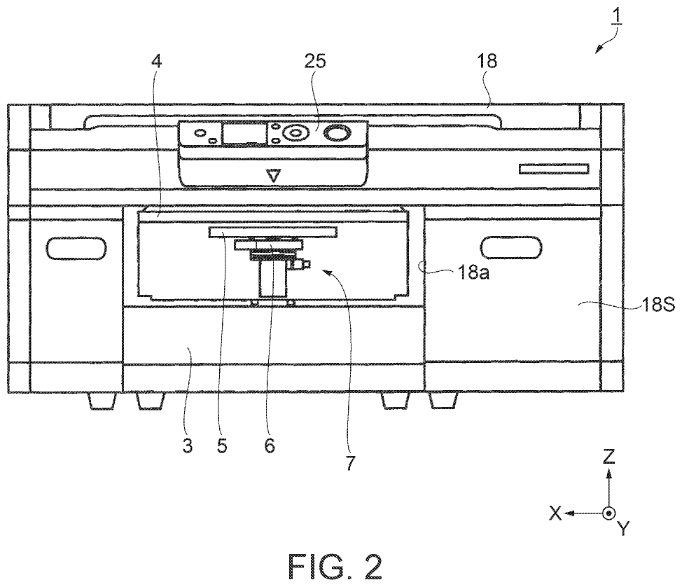

As shown in FIG. 2, the medium support device 7 is installed above the transport section 3. The tray 4 is installed in the upward direction of the medium support device 7. FIG. 2 shows a state in which the T-shirt F is not set.

A medium support device 7 includes a support base 5 and a movement mechanism 6. The support base 5 is located at the uppermost position of the medium support device 7, and supports a lower surface of the tray 4. That is, the support base 5 supports the T-shirt F via the tray 4. The tray 4 is detachable from and attachable to the support base 5.

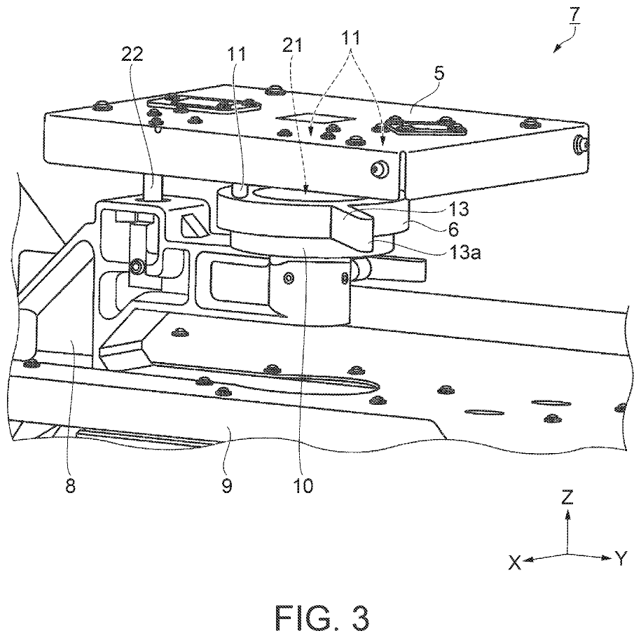

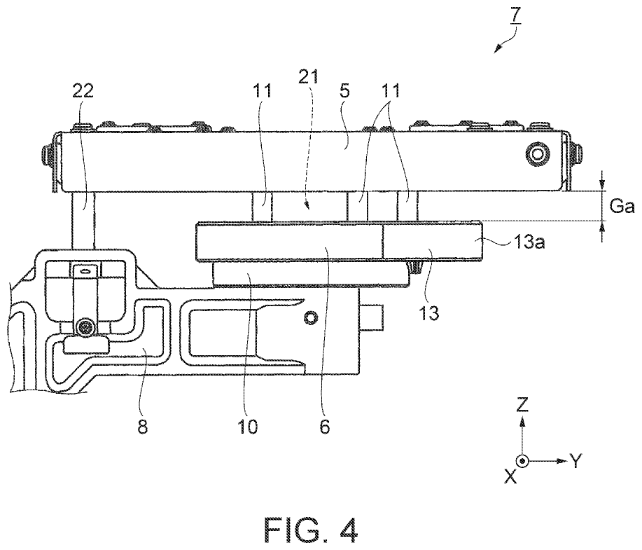

As shown in FIG. 3, the medium support device 7 according to the present embodiment includes a base section 8, a lower section support member 9, a spacer 10, pins 11, a columnar section 21, and a rod-shaped section 22 in addition to the support base 5 and the movement mechanism 6 described above. In the medium support device 7, the support base 5, the pins 11, the movement mechanism 6, the spacer 10, the base section 8, and the lower section support member 9 are arranged in this order from top to bottom. In FIG. 3 and FIG. 4 (to be described later), a cover, a protective wall, and a handle member (to be described later) are detached for convenience of describing internal configuration of the medium support device 7.

The support base 5 has a substantially rectangular plate shape in plan view from above. An upper main surface of the support base 5 is along the XY plane. Three pins 11 are fixed below the support base 5. Each of the pins 11 is a substantially cylindrical member, and has an axial center along the Z-axis in an installed state. A lower end section of each pin 11 is supported in contact with a stair-like section (to be described later) of the movement mechanism 6.

The movement mechanism 6 is substantially circular in plan view from the upward direction. The movement mechanism 6 movably supports the support base 5 in a direction along the Z-axis, which is the vertical direction, via the three pins 11. Specifically, the movement mechanism 6 includes a lever 13 that moves the support base 5 along the Z-axis. When a user of the medium support device 7 operates the lever 13, lower end sections of the three pins 11 are moved up and down by the movement mechanism 6. As a result, the support base 5 moves in a direction along the Z-axis with respect to the movement mechanism 6, the base section 8, and the like.

When the support base 5 moves in the direction along the Z-axis, the tray 4 supported by the support base 5 also moves in the direction along the Z-axis, and a distance between the T-shirt F set on the tray 4 and the recording head 2 is changed. Therefore, the above-described distance is increased, for example, when the medium such as the T-shirt F is thick. The distance is reduced when the medium is thin. In this way, it is possible to optimally set the distance.

In addition to the three pins 11, a columnar section 21 and a rod-shaped section 22 are arranged below the support base 5. The three pins 11, the columnar section 21, and the rod-shaped section 22 are movable in the vertical direction together with the support base 5. The columnar section 21 and the rod-shaped section 22 are substantially cylindrical members, and have axial centers along the Z-axis in an installed state. The rod-shaped section 22 is arranged in the −Y direction with respect to the movement mechanism 6. The lower end section of the rod-shaped section 22 is fitted to an opening (not shown) of the base section 8. The support base 5 is positioned along the XY plane by the rod-shaped section 22, the three pins 11, and the like.

The spacer 10 is arranged between the movement mechanism 6 and the base section 8 in a direction along the Z-axis. The spacer 10 is supported by the base section 8 at an end section of the base section 8 in the +Y direction, and supports a lower section of the movement mechanism 6. The spacer 10 is detachable from and attachable to the medium support device 7. Specifically, the spacer 10 can be inserted and pulled out in a direction along the Y-axis, which is a direction intersecting a direction along the Z-axis. The spacer 10 is attached and detached when it is desired to change the distance between the T-shirt F and the recording head 2 to larger than by adjustment by the movement mechanism 6.

When the spacer 10 is attached, since the movement mechanism 6 is separated from the base section 8, the support base 5 approaches the recording head 2 (not shown). When the spacer 10 is detached, the movement mechanism 6 approaches the base section 8, so the support base 5 separates from the recording head 2.

The base section 8 is capable of supporting the movement mechanism 6. Specifically, when the spacer 10 is used, the base section 8 supports the movement mechanism 6 via the spacer 10, and when the spacer 10 is not used, the base section 8 contacts and supports the moving mechanism 6.

The base section 8 has an elongated shape along the Y-axis in plan view from above. A lower section of the base section 8 is fixed to the lower section support member 9 at an end section in the −Y direction, and is separated from the lower section support member 9 except for the vicinity of the end section. When the T-shirt F is set, cloth of the back side of the T-shirt F is inserted into a region where the lower section of the base section 8 and the lower section support member 9 are separated from each other. That is, the above-described region is a clearance of the cloth of the back side of the T-shirt F. Therefore, a chest side of a set T-shirt F is less likely to be wrinkled.

As described above, the base section 8 supports the spacer 10, the movement mechanism 6, the support base 5, the tray 4, and the like. For this reason, the base section 8 is made of a material with excellent strength such as metal.

The lower section support member 9 supports the base section 8 on its upper surface, and is supported by the transport section 3 (not shown) on its lower section. The transport section 3 moves the lower section support member 9 in a direction along the Y-axis. Accordingly, the T-shirt F set on the medium support device 7 and the tray 4 is also moved in the direction along the Y-axis.

As shown in FIG. 4, a gap Ga exists between an upper section of the movement mechanism 6 and a lower section of the support base 5 in plan view from the +X direction. The gap Ga exists regardless of the presence or absence of the spacer 10. The distance of the gap Ga in a direction along the Z-axis is changed by changing a position of the support base 5 in the vertical direction by operating the lever 13.

Here, when setting the T-shirt F, the following procedure is performed. First, the tray 4 (not shown) is attached to the support base 5. Next, the tray 4 is covered with the T-shirt F from an end section of the tray 4 in the +Y direction so as to be worn. At this time, wrinkles in the cloth of the chest side of the T-shirt F are smoothed out along the surface of the tray 4. The cloth on a back side of the T-shirt F is guided downward and in the −Y direction so that the end sections of the movement mechanism 6, the spacer 10, and the base section 8 in the +Y direction are put inside the T-shirt F. Then, the hem of the T-shirt F is inserted between the base section 8 and the lower section support member 9 (not shown).

The base section 8 supports the spacer 10, the spacer 10 supports the movement mechanism 6, and the movement mechanism 6 supports the support base 5 via the pins 11. When the spacer 10 is detached, the base section 8 directly supports the movement mechanism 6. Therefore, when the spacer 10 is attached to the medium support device 7, the support base 5 moves upward by the length of the spacer 10 in a direction along the Z-axis, with respect to a state in which the spacer 10 is detached.

A plurality of spacers 10 can be attached to the medium support device 7. A plurality of types of spacers 10 having different lengths in a direction along the Z-axis may be prepared. By this, the position of the support base 5 in a direction along the Z-axis can be appropriately adjusted. Details of the spacer 10 will be described later.

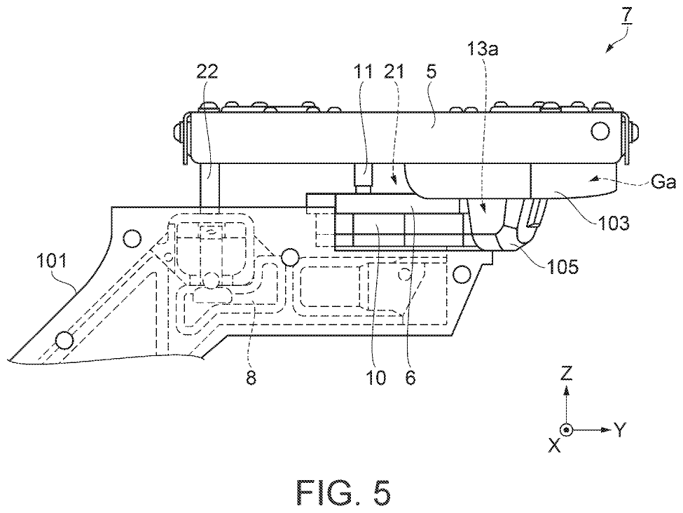

As shown in FIG. 5, the medium support device 7 includes a cover 101, a protective wall 103, and a handle member 105. In FIG. 5, in order to explain an arrangement of the base section 8 and the cover 101, the base section 8 covered with the cover 101 is shown by broken line.

The cover 101 covers the entire base section 8. The cover 101 is made of a material that can be easily molded, such as resin. The cover 101 has a smooth outer surface compared to the base section 8. Therefore, when the T-shirt F is set, the T-shirt F can be easily moved along the cover 101.

The protective wall 103 is fixed in the downward direction and in the +Y direction of the support base 5. The protective wall 103 is arranged so as to cover, from a side view from the +Y direction, the gap Ga between the support base 5 and the movement mechanism 6. Specifically, the protective wall 103 has an arc shape in plan view from above, has a radius larger than that of the movement mechanism 6, and is arranged to correspond to the +Y direction and the left-right direction of the movement mechanism 6.

The handle member 105 covers a tip end section 13a of the lever 13. The handle member 105 has a shape in which the grip is thicker than the tip end section 13a. Specifically, the handle member 105 is made of a material that can be easily molded, such as resin. The handle member 105 has a thick and round shape compared with a slim lever 13. Therefore, the T-shirt F is less likely to be caught as compared with the tip end section 13a alone.

The protective wall 103 covers the gap Ga and has a shape that does not interfere with pivot of the handle member 105 and the lever 13. The protective wall 103 makes it difficult for the T-shirt F to enter into the gap Ga between the support base 5 and the movement mechanism 6.

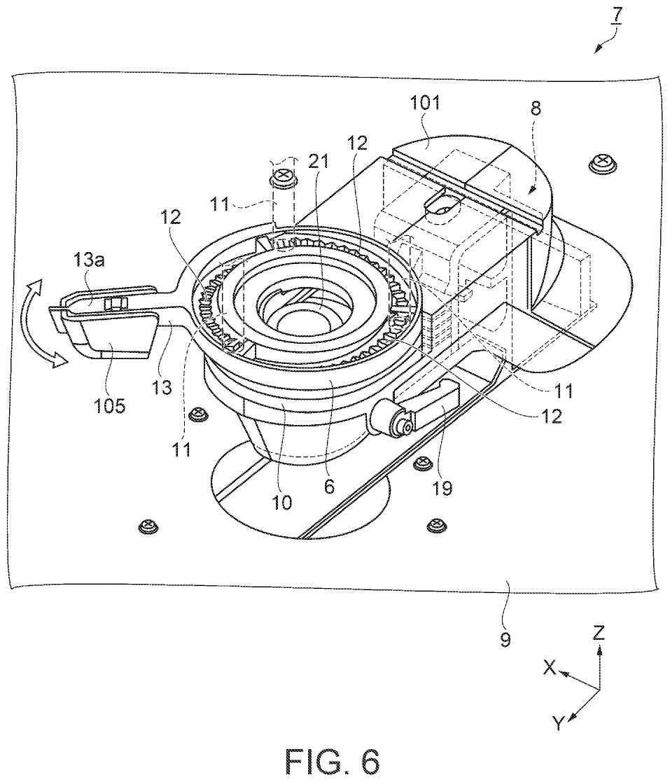

As shown in FIG. 6, the columnar section 21 is arranged in a region corresponding to a center of the substantially circular movement mechanism 6 in plan view from above. In FIG. 6, a state in which the support base 5 is detached is shown, and the three pins 11 are shown by broken lines. In the following description of FIG. 6, unless otherwise specified, a state in plan view from the upward direction will be described.

The movement mechanism 6 is not fixed to the columnar section 21 nor to the spacer 10 below. The movement mechanism 6 can be pivoted clockwise and counterclockwise. The rotation axis of the movement mechanism 6 and the center of the circular columnar section 21 coincide with each other.

The lever 13 is arranged so as to protrude from an outer periphery of the movement mechanism 6. A user of the medium support device 7 can pivot the movement mechanism 6 via the lever 13. Although not shown, the rotation angle of the movement mechanism 6 is restricted to within about 120° by a stopper. FIG. 6 shows a state in which the movement mechanism 6 is pivoted most clockwise.

A stair-like section 12 is provided on an inner side in a vicinity of an outer periphery of the movement mechanism 6. The stair-like section 12 is in contact with lower end sections of the three pins 11 and supports the above-described support base 5 via the three pins 11. The three pins 11 are arranged at intervals of 120° with a center of the columnar section 21 as a virtual center, corresponding to a rotation angle of the movement mechanism 6. The stair-like section 12 is divided into three regions corresponding to each of the three pins 11.

Each of the three regions is provided with a plurality of steps having different heights in the Z-axis direction. In each stair-like section 12, height of a step in a direction along the Z-axis is aligned so as to be the same corresponding to the three pins 11. Therefore, when the movement mechanism 6 is rotated using the lever 13, each pin 11 rides on a step of the stair-like section 12, and position of the support base 5 in a direction along the Z-axis, that is, height of the support base 5 is adjusted. Therefore, the distance between the recording head 2 and the T-shirt F set on the support base 5 can be easily adjusted.

A lock lever 19 is connected to the base section 8 on the −X direction side of the columnar section 21. In the lock lever 19, a screw section (not shown) is screwed into the base section 8, and a tip end of the screw section of the lock lever 19 is structured to press and fix the columnar section 21 from a lateral direction. By loosening the screw section of the lock lever 19, an unlocked state is achieved in which the columnar section 21 is movable in the vertical direction. By tightening the screw section of the lock lever 19, a locked state is achieved in which a movement of the columnar section 21 in the vertical direction is restricted. The lock lever 19 switches between the unlocked state and the locked state in the columnar section 21.

The columnar section 21 and the support base 5 are connected to each other, and the support base 5 can be moved in the vertical direction by setting the columnar section 21 to the unlocked state. That is, when the position of the support base 5 in the vertical direction is changed by operation of the lever 13, the columnar section 21 is set to the unlocked state. When the columnar section 21 is set to the unlocked state and the support base 5 and the columnar section 21 are detached from the base section 8, the movement mechanism 6 can be detached. When it is desired to fix the position of the support base 5 in the vertical direction, the columnar section 21 is set to the locked state.

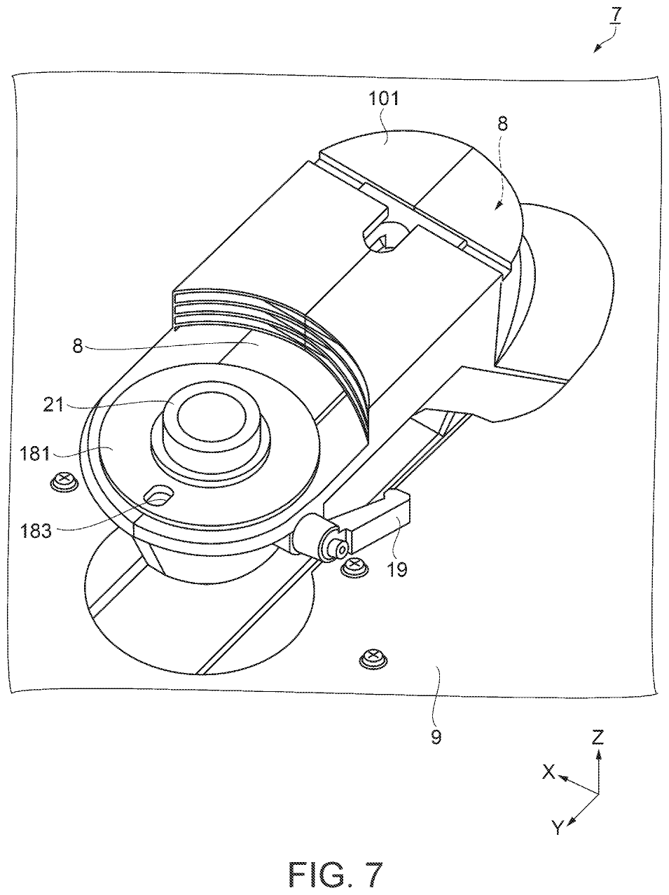

As shown in FIG. 7, the base section 8 includes a placement section 181 and a recess section 183. The placement section 181 circularly surrounds the columnar section 21 at an end section of the base section 8 in the +Y direction. The placement section 181 is a substantially flat region along the XY plane, and supports the spacer 10 attached to the medium support device 7 or the movement mechanism 6 from the downward direction.

The columnar section 21 is a substantially cylindrical member, and a longitudinal direction of the cylinder is along the Z-axis. An upper section of the columnar section 21 protrudes upward from the base section 8, and a lower section of the columnar section 21 passes through the base section 8.

The recess section 183 is provided in the placement section 181 and arranged in the +Y direction of the columnar section 21. The recess section 183 is a recess in the upper surface of the placement section 181. The recess section 183 is engaged with a lower section engagement section (to be described later) of the spacer 10.

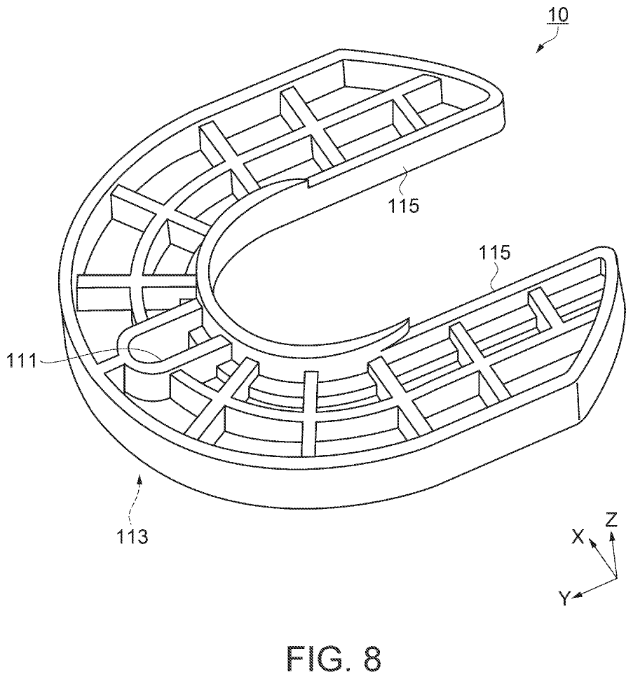

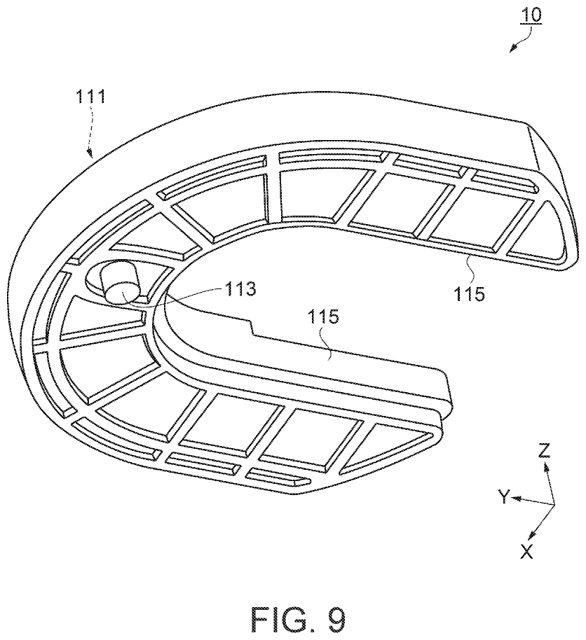

As shown in FIGS. 8 and 9, the spacer 10 is substantially U-shaped in plan view from above. The spacer 10 includes a cutout section 115, and an upper section engagement section 111 and a lower section engagement section 113 as engaging sections. An inner side of the spacer 10 has a curved surface corresponding to the substantially cylindrical columnar section 21.

When the spacer 10 is attached to the medium support device 7, the spacer 10 is fitted into an upper section of the above-described columnar section 21 from the +Y direction through the cutout section 115. When the spacer 10 is detached from the medium support device 7, the spacer 10 is pulled out in the +Y direction through the cutout section 115 with respect to an upper section of the columnar section 21.

That is, the spacer 10 can be inserted and pulled out with respect to the columnar section 21. Accordingly, when the spacer 10 is attached to and detached from the movement mechanism 6, the spacer 10 can be attached and detached more easily than when, for example, a ring-shaped spacer is used.

The upper section engagement section 111 and the lower section engagement section 113 are arranged in the +Y direction in the spacer 10. The upper section engagement section 111 and the lower section engagement section 113 face each other in a direction along the Z-axis, and when the spacer 10 is attached to the movement mechanism 6, they are located at positions overlapping with the recess section 183 of the above-described placement section 181 in a transparent view from the +Z direction.

The upper section engagement section 111 is a recess with respect to the XY plane. The lower section engagement section 113 is a protrusion with respect to the XY plane. The lower section engagement section 113 has a shape capable of engaging with the recess section 183 and an upper section engagement section 111 of the other spacer 10.

The lower section engagement section 113 engages with the recess section 183 of the base section 8 when the spacer 10 is attached to the medium support device 7. When a plurality of spacers 10 are used, the spacers 10 are engaged with each other at the upper section engagement section 111 and the lower section engagement section 113. This facilitates an alignment of the spacer 10 with the base section 8 and an alignment of a plurality of spacers 10 with each other, thereby further improving workability of attaching and detaching the spacer 10.

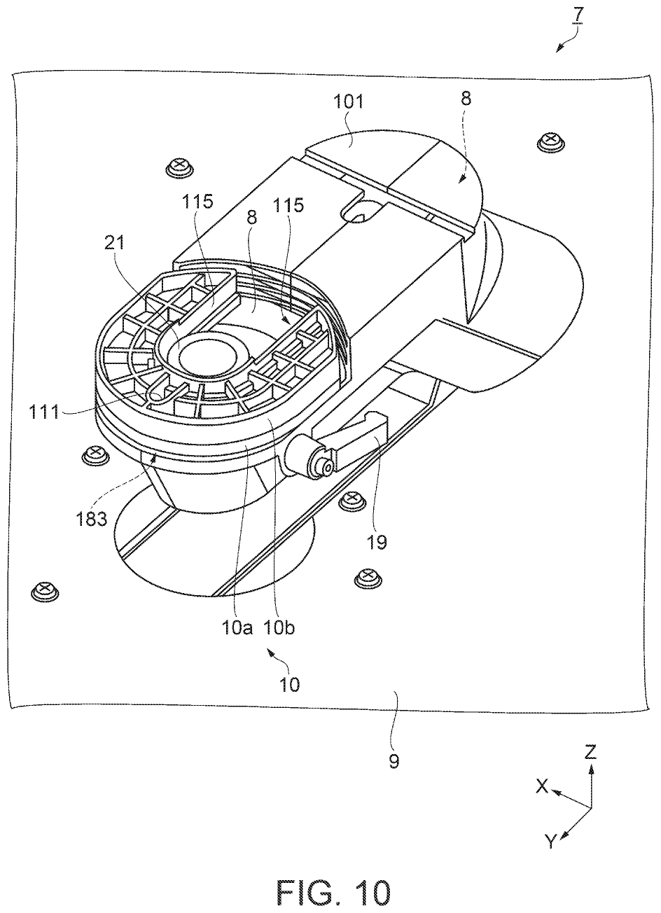

As shown in FIG. 10, two spacers 10a and 10b can be attached to the movement mechanism 6 as a plurality of spacers 10. A plurality of spacers 10a and 10b have different lengths in a direction along the Z-axis, that is, different thicknesses. The thickness of the spacer 10a is thinner than the thickness of the spacer 10b. For example, the spacer 10a has a thickness of 6 mm, and the spacer 10b has a thickness of 10 mm. Accordingly, an adjustment of the distance between the support base 5 and the recording head 2 described above is further facilitated in accordance with the thickness of the medium such as the T-shirt F.

An example of a procedure for attaching and detaching the spacer 10 to and from the medium support device 7 will be described. This work can be performed while the support base 5 (not shown) is attached to the medium support device 7. First, the lever 13 of the movement mechanism 6 (not shown) is pivoted as far as possible counterclockwise to move the support base 5 as far as possible downward.

Next, after operating the lock lever 19 to make the columnar section 21 movable in the vertical direction in the unlocked state, the support base 5 is lifted upward. Then, in a state in which the support base 5 is lifted upward, the lock lever 19 is used to set the locked state in which movement of the columnar section 21 in the vertical direction is restricted. As a result, the support base 5 is in a state of floating above the movement mechanism 6.

Next, the movement mechanism 6 is lifted upward to attach and detach the spacer 10. Thereafter, after the movement mechanism 6 is lowered, the lock lever 19 is operated to set the unlocked state in which the columnar section 21 is movable in the vertical direction, the support base 5 is lowered to a position at which the three pins 11 are supported by the movement mechanism 6, and the locked state is set in which movement of the columnar section 21 in the vertical direction is restricted. The spacer 10 is attached and detached by the above-described procedure. When the plurality of spacers 10a and 10b are attached, the spacers 10a and 10b may be attached to the medium support device 7 in a state of being engaged with each other.

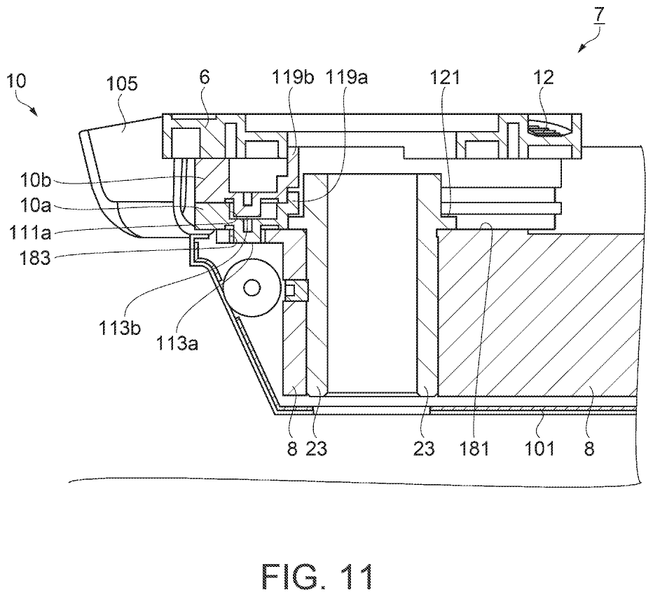

As shown in FIG. 11, a cylindrical section 23 having a hollow central portion is incorporated in the base section 8. The cylindrical section 23 has a hollow central portion through which the columnar section 21 can be passed. The inside diameter of the hollow central portion of the cylindrical section 23 is substantially equal to the outer diameter of the columnar section 21. The cylindrical section 23 allows the columnar section 21 to pass through the base section 8 while suppressing displacement of the columnar section 21 in a direction intersecting the passing direction of the columnar section 21. The screw section of the lock lever 19 comes into contact with the columnar section 21 through an opening section provided in the cylindrical section 23, and switches between the unlocked state and the locked state. The cylindrical section 23 has a flange section 121. A lower section of the flange section 121 is in contact with the placement section 181 of the base section 8.

The lower section engagement section 113a of the spacer 10a is engaged with the recess section 183 of the base section 8. Part of the lower section of the spacer 10a is in contact with the placement section 181, and an edge section 119a is in contact with the flange section 121. A lower section engagement section 113b of the spacer 10b is engaged with an upper section engagement section 111a of the spacer 10a. A lower part of the outer edge of the spacer 10b is in contact with an upper part of the outer edge of the spacer 10a. An edge section 119b of the spacer 10b is in contact with an edge section 119a of the spacer 10a. The movement mechanism 6 is supported in contact with an upper part of the outer edge of the spacer 10b, and is also in contact with the edge section 119b of the spacer 10b.

As described above, each configuration is positioned by engaging or contacting the spacers 10a and 10b and the movement mechanism 6 with the base section 8 and the columnar section 21.

According to the present embodiment, the following effects can be obtained. Workability of attaching and detaching the spacer 10 can be improved. Specifically, the spacer 10 can be inserted and pulled out with respect to the medium support device 7 in a direction along the Y-axis. Therefore, the spacer 10 can be attached and detached without detaching the movement mechanism 6 and the support base 5. Therefore, it is possible to provide the medium support device 7 and the recording device 1 that improve workability of attaching and detaching the spacer 10.

What is claimed is:

1. A medium support device comprising:
a support base that supports a medium;
a movement mechanism that supports the support base so that the support base is movable in a vertical direction;
a base section configured to support the movement mechanism; and
a spacer arranged between the movement mechanism and the base section in the vertical direction, wherein
the spacer is configured to be inserted and pulled out in a direction intersecting the vertical direction.

2. The medium support device according to claim 1, wherein
the spacer includes an engagement section that engages with the base section.

3. The medium support device according to claim 2, wherein
a plurality of the spacers are configured to be attached and detached and
the spacers are engaged with each other at the engagement section.

4. The medium support device according to claim 3, wherein
the plurality of spacers have different lengths in the vertical direction.

5. The medium support device according to claim 1, further comprising:
a columnar section that passes through the base section and the movement mechanism, wherein
the spacer includes a cutout section that is configured to enable being inserted and pulled out with respect to the columnar section.

6. A recording device comprising:
a recording head that applies ink to a medium and
a medium support device, wherein
the medium support device includes
a support base that supports the medium,
a movement mechanism that supports the support base so that the support base is movable in a vertical direction,
a base section configured to support the movement mechanism, and
a spacer arranged between the movement mechanism and the base section in the vertical direction and
the spacer is configured to be inserted and pulled out in a direction intersecting the vertical direction.
